(19) United States
(12) Patent Application Publication
(10) Pub. No.: US 2026/0292566 A1
(43) Pub. Date: Sep. 24, 2026

(54) Methods And Apparatus For Enhancing Measurement Report In Mobile Communications

(71) Applicant: MediaTek Inc., Hsinchu City (TW)

(72) Inventors: Jen-Chien Liu, Hsinchu City (TW); Keng-Ming Huang, Hsinchu City (TW); Chun-Fan Tsai, Hsinchu City (TW)

(73) Assignee: MediaTek Inc., Hsinchu City (TW)

(21) Appl. No.: 19/464,658

(22) Filed: Jan. 30, 2026

Related U.S. Application Data
(60) Provisional application No. 63/762,683, filed on Feb. 25, 2025.

(51) Int. Cl. H04W 24/10; H04B 17/309; H04B 17/318; H04W 36/00; H04W 36/32

(52) U.S. Cl. CPC H04W 24/10; H04B 17/328; H04B 17/346; H04W 36/0058; H04W 36/324

(57) ABSTRACT

Various solutions for measurement report enhancement in mobile communications are described. The user equipment (UE) may receive a measurement configuration from a network node. The measurement configuration may indicate a measurement report criterion for triggering a measurement report based on a movement speed. The UE may perform a radio signal measurement on at least one cell to obtain at least one radio measurement data. The UE may derive a temporal variation rate of the radio measurement data. The UE may transmit a measurement report comprising the temporal variation rate of the radio measurement data to the network node.

### CROSS REFERENCE TO RELATED PATENT APPLICATION(S)

The present disclosure is part of a non-provisional application claiming the priority benefit of U.S. Patent Application No. 63/762,683, filed 25 Feb. 2025, the content of which herein being incorporated by reference in its entirety.

### TECHNICAL FIELD

The present disclosure is generally related to mobile communications and, more particularly, to measurement report enhancement in mobile communications.

### BACKGROUND

Unless otherwise indicated herein, approaches described in this section are not prior art to the claims listed below and are not admitted as prior art by inclusion in this section.

In mobile communication, the ability to accurately acquire the status of a user equipment (UE) is critical for ensuring efficient network management and service continuity. One of the key mechanisms for monitoring the channel condition of a UE with respect to the network is by triggering measurement reports. These reports typically provide vital information about the UE's current state, including signal strength, quality, and other relevant parameters. The measurement report plays a crucial role in enabling mobility management, such as handover, allowing the UE to seamlessly transition from one cell to another to maintain connectivity, especially when moving across coverage areas.

However, existing methods for generating and utilizing measurement reports have significant limitations, particularly in situations involving mobility. A primary challenge is the inability to accurately determine the speed of the UE based on the information provided in the measurement reports. FIG. 1 illustrates an example scenario of a communication environment in which the network provides a measurement configuration without considering the moving speed of the user equipment (UE). As shown in FIG. 1, the horizontal axis represents time, and the vertical axis represents the received signal strength or quality of the serving cell. Further, TTT represents the time-to-trigger; MR represents the measurement report; and HO represents the handover command from the serving cell.

During normal mobility conditions, the UE follows the configured measurement reporting behavior, and the handover is triggered at an appropriate time when the serving-cell signal gradually degrades, and the target-cell signal becomes stronger. This normal handover case is depicted by the solid curves 100, where the serving-cell signal crosses below the handover threshold slightly before the target-cell signal crosses above its threshold, allowing the network to initiate handover at the right moment.

However, when the UE is moving at a higher speed, the static measurement configuration becomes suboptimal. As illustrated by the dashed curves 110, the serving-cell signal strength drops rapidly, and the UE reaches the handover region much earlier than anticipated by the measurement configuration. Because the reporting and evaluation timing do not take the UE's velocity into account, the network detects the handover condition too late, and the handover command arrives after the serving-cell signal has already degraded below an acceptable level, leading to a too-late handover situation, resulting in a higher probability of radio link failure or service interruption.

Since the measurement report typically focuses on signal-related measures without considering the UE's velocity, it fails to provide the network with real-time insights into how quickly the UE is moving. This missing data results in a significant blind spot in predicting the appropriate timing for handover in the network. Without the information on the UE's speed, the network may find it difficult to timely initiate the handover process. If the UE is moving quickly and the handover is not promptly triggered, there is a risk that the connection will be lost before the UE can successfully transition to a new cell. As a result, this limitation can lead to service disruptions and poor user experience, particularly in high-speed mobility scenarios such as vehicular networks or high-speed trains.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to measurement report enhancement in mobile communications.

In one aspect, a method may involve an apparatus receiving a measurement configuration from a network node. The measurement configuration may indicate a measurement report criterion for triggering a measurement report based on a movement speed. The method may also involve the apparatus performing a radio signal measurement on at least one cell to obtain at least one radio measurement data. The method may further involve the apparatus deriving a temporal variation rate of the radio measurement data. The method may further involve transmitting the measurement report including the temporal variation rate of the radio measurement data to the network node.

In another aspect, a method may involve a network node transmitting a measurement configuration. The method may also involve the network node receiving a measurement report including a temporal variation rate of at least one radio measurement data from an apparatus. The method may further involve determining whether to initiate a mobility-related procedure of the apparatus based on the temporal variation rate of the radio measurement data.

In yet another aspect, an apparatus may include a transceiver which, during operation, wirelessly communicates with a network node of a wireless network. The apparatus may also include a processor communicatively coupled to the transceiver. The processor, during operation, may perform operations including receiving, via the transceiver, a measurement configuration from the network node. The measurement configuration may indicate a measurement report criterion for triggering a measurement reporting based on a movement speed. The processor, during operation, may also perform operations comprising performing a radio signal measurement on at least one cell to obtain at least one radio measurement data. The processor, during operation, may further perform operations including deriving a temporal variation rate of the radio measurement data. The processor, during operation, may further perform operations including transmitting, via the transceiver, a measurement report including the temporal variation rate of the radio measurement data to the network node.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 illustrates an example scenario of a communication scenario in which the network provides a measurement configuration without considering the moving speed of the user equipment (UE) in accordance with the conventional art.

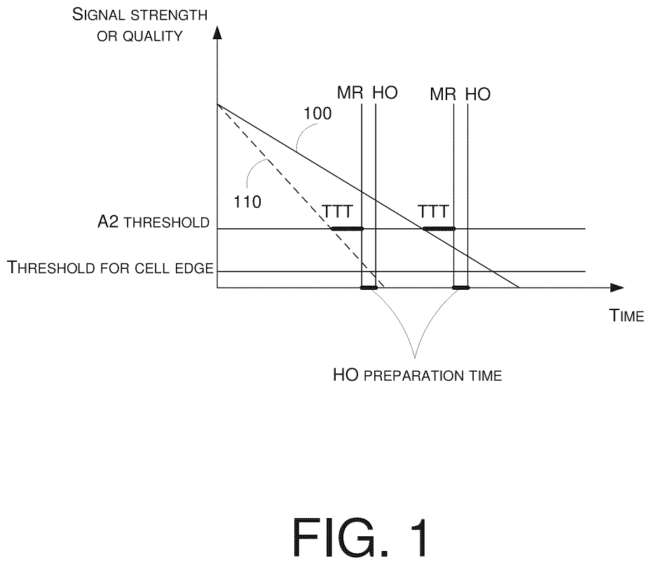

FIG. 2 illustrates an example scenario 200 of a communication environment in which various solutions and schemes in accordance with the present disclosure may be implemented.

FIG. 3 is a diagram depicting an example scenario 300 in which the UE measurement reporting behavior is influenced by a configuration parameter included in the measurement configuration message.

FIG. 4 is a diagram illustrating an example scenario 400 in which the network provides distinct filtering configurations for different UE mobility conditions through the QuantityConfigNR structure.

FIG. 5 is a diagram illustrating an example scenario 500 in which the network provides distinct or scaled event-triggering configurations for fast-moving UEs in the EventTriggerConfig structure.

FIG. 6 illustrates an example communication system 600 having an example communication apparatus 610 and an example network apparatus 620 in accordance with an implementation of the present disclosure.

FIG. 7 is a flowchart of an example process in accordance with an implementation of the present disclosure.

FIG. 8 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to measurement report enhancement in mobile communications. According to the present disclosure, a number of possible solutions may be implemented separately or jointly. That is, although these possible solutions may be described below separately, two or more of these possible solutions may be implemented in one combination or another.

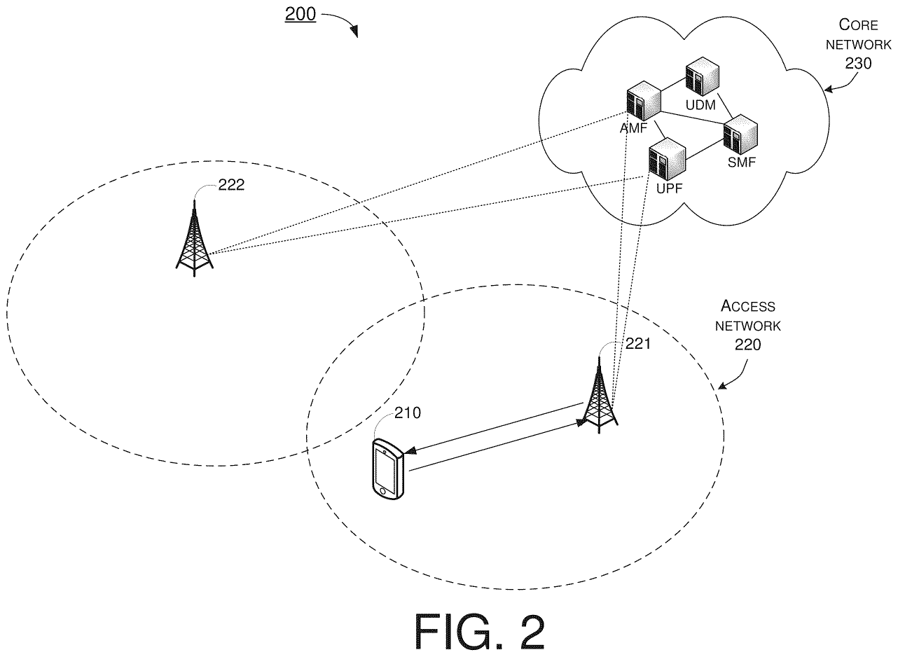

FIG. 2 illustrates an example scenario 200 of a communication environment in which various solutions and schemes in accordance with the present disclosure may be implemented. Scenario 200 involves a UE 210 in wireless communication with a wireless communication network (e.g., an LTE network, a 5G/NR network, an IoT network, or a 6G network) consisting of an access network 220 and a core network 230. The UE 210 may be a smart phone, a wearable device, an IoT device, a tablet, etc. Alternatively, the UE 210 may be a notebook (NB) or personal computer (PC) inserted or installed with a data card which includes a modem and radio frequency (RF) transceiver(s) to provide the functionality of wireless communication. In one embodiment, the access network 220 is connected to the core network 230 by means of the NG interface, more specifically to a user plane function (UPF) by means of the NG user-plane part (NG-u), and to an access and mobility management function (AMF) by means of the NG control-plane part (NG-c). The access network 220 may include a base station (BS) 221, which may be connected to multiple UPFs/AMFs for the purpose of load sharing and redundancy. In addition, the core network may include other entities, such as a session management function (SMF) and a unified data management (UDM), etc. In some embodiments, the access network 220 may include multiple BSs, such as BS 222, each of which may provide communication coverage for a geographic coverage area where communications with the UE 210 are supported.

In scenario 200, a scheme for enhancing the measurement reporting procedure by incorporating UE 210 mobility information within the wireless communication network is provided. The BS 221 may send a measurement configuration message to the UE 210, instructing the UE 210 to perform measurements related to signal strength and quality. In conventional systems, the UE 210 reports only these radio measurement data, without providing any information of its movement speed, which may result in delayed or failed handover decisions. To address this issue, the measurement configuration message may include at least one additional measurement parameter for speed reporting, where the UE 210 may derive speed information based on the temporal variation rate of the radio measurement data (e.g., the measured signal strength and/or quality such as the RSRP/RSRQ/SINR between UE 210 and both BS 221 and 222). Upon receiving this measurement configuration, the UE 210 may determine whether its movement speed surpasses a predefined threshold or a given threshold, such as a temporal variation rate. Consequently, when the threshold is surpassed, the UE 210 may determine the conventional radio measurement data (e.g., signal strength and/or quality such as the RSRP/RSRQ/SINR) as well as a temporal variation rate of the radio measurement data. The UE 210 may then include this enhanced radio measurement data in the measurement report and transmit the measurement report to the BS 221.

In one embodiment, the UE 210 may receive a measurement configuration from the BS 221, where the measurement configuration indicates a measurement report criterion for triggering a measurement report. The UE 210 may then perform radio signal measurements on at least one cell (e.g., the BS 221 and the BS 222) to obtain radio measurement data. In some cases, the measurement configuration may further specify a temporal condition, such as a required duration for which a measurement condition is satisfied or any other stability-related requirement, and the UE 210 may evaluate the measurement data according to such a temporal condition when deriving a temporal variation rate. For example, the UE 210 may determine the degree of change of the measurement values over time based on consecutive measurements that satisfy the specified temporal condition. Subsequently, the UE 210 may include the temporal variation rate in a measurement report and transmit the measurement report to the NB 221, thereby enabling the NB 221 to utilize the temporal variation information for mobility management or related decision-making, such as handover procedures.

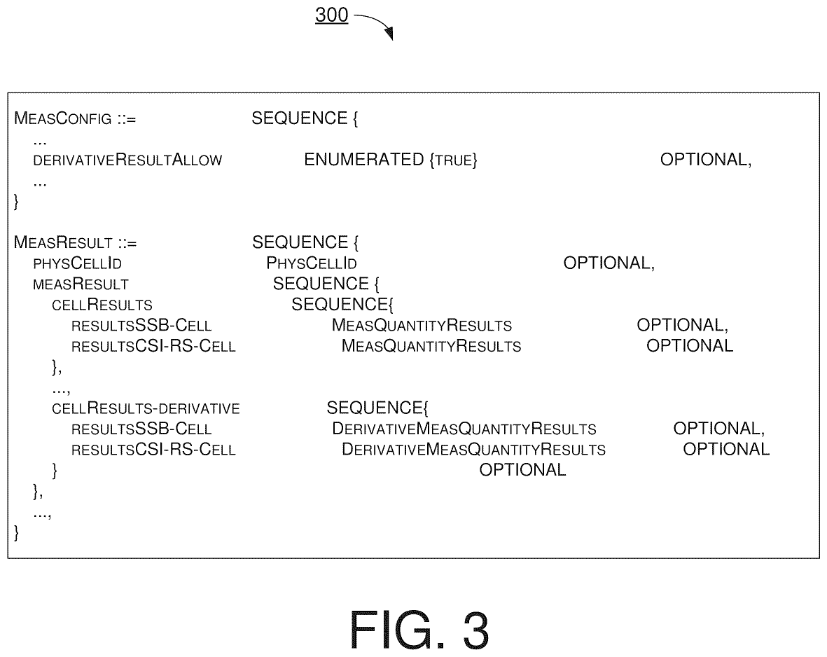

FIG. 3 is a diagram depicting an example scenario 300 in which the UE measurement reporting behavior is influenced by a configuration parameter included in the measurement configuration message. In scenario 300, the measurement configuration MeasConfig sent by the network may contain the temporal variation rate parameter (e.g., derivativeResultAllow=true). Based on the presence and value of this indication, the UE 210 may determine whether the temporal variation rate of the measurement data should be included in its measurement reports. More specifically, when derivativeResultAllow is set to true, the UE 210 may supplement the conventional measurement data with additional temporal variation rate of measurement data, such as derivative of a reference signal received power (RSRP) over time, a reference signal received quality (RSRQ) over time, and/or a signal to interference plus noise ratio (SINR) over time. In this case, while preparing a MeasResult message, the UE 210 may provide the standard cell measurement data (e.g., resultsSSB-Cell and resultsCSI-RS-Cell within cellResults) as well as the corresponding temporal variation rate of the measurement data (e.g., resultsSSB-Cell and resultsCSI-RS-Cell within cellResults-derivative). These temporal variation rates of the measurement data may represent rate-of-change or time-based variation data associated with the received SSB or CSI-RS signals. In contrast, if the value of derivativeResultAllow is absent or set to false, the UE may compile the MeasResult by including only the conventional measurement quantities. That is, the UE 210 may report results under cellResults, but the cellResults-derivative structure may be omitted entirely. As a result, the UE 210 reports only standard measurement data without any temporal variation information. Thus, based on the value of derivativeResultAllow, the network can control whether the UE 210 should include the temporal-variation rate of measurement data in its reporting. This provides enhanced measurement visibility as needed and avoids unnecessary signaling overhead if the derivative information is not required.

In another embodiment, the BS 221 may send the measurement configuration with parameters including a threshold corresponding to the temporal variation rate of the radio measurement data and the fast-moving event parameter set. The UE 210 may evaluate the measurement report criterion based on the temporal variation rate of the radio measurement data in an event that the threshold is included in the measurement configuration. In an event that the temporal variation rate of the radio measurement data surpasses the threshold, the UE 210 may determine that the measurement report is triggered by using the fast-moving event parameter set.

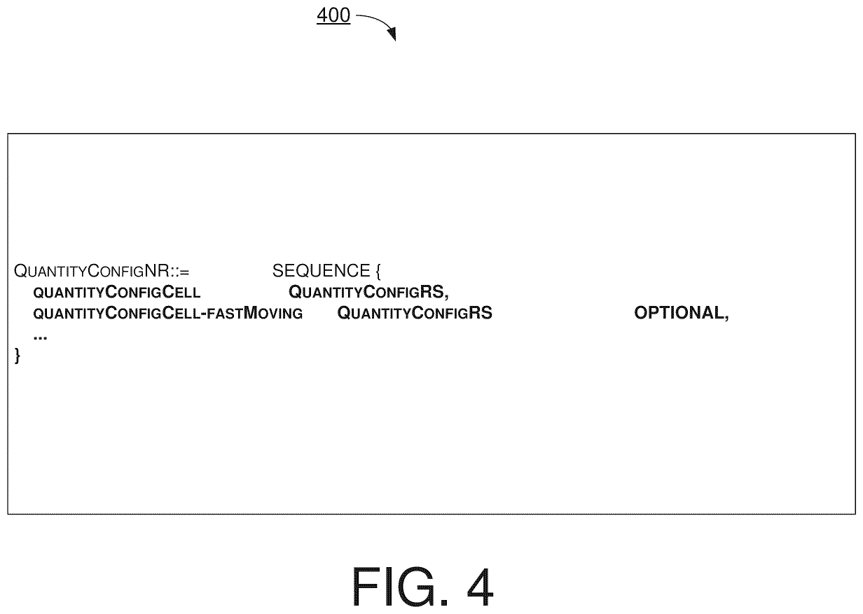

FIG. 4 is a diagram illustrating an example scenario 400 in which the network provides distinct filtering configurations for different UE mobility conditions through the QuantityConfigNR structure. In scenario 400, the QuantityConfigNR may include a quantityConfigCell parameter for normal mobility and an optional quantityConfigCell-fastMoving parameter for UEs experiencing rapid temporal variation in radio measurements. When the UE 210 detects that the temporal variation rate, such as the derivative of RSRP, RSRQ, or SINR with respect to time, surpasses a threshold previously configured by the BS 221, the UE 210 may determine that it has entered a fast-moving condition and accordingly switch to the filter configuration specified in quantityConfigCell-fastMoving. This fast-moving configuration may employ a smaller filterCoefficient value to allow the UE's measurement data to respond more rapidly to fast variations in signal conditions. By providing differentiated filter configurations, the network is able to obtain more accurate and timely measurement results, thereby improving the precision of mobility-related decisions and enhancing overall handover and mobility procedure performance.

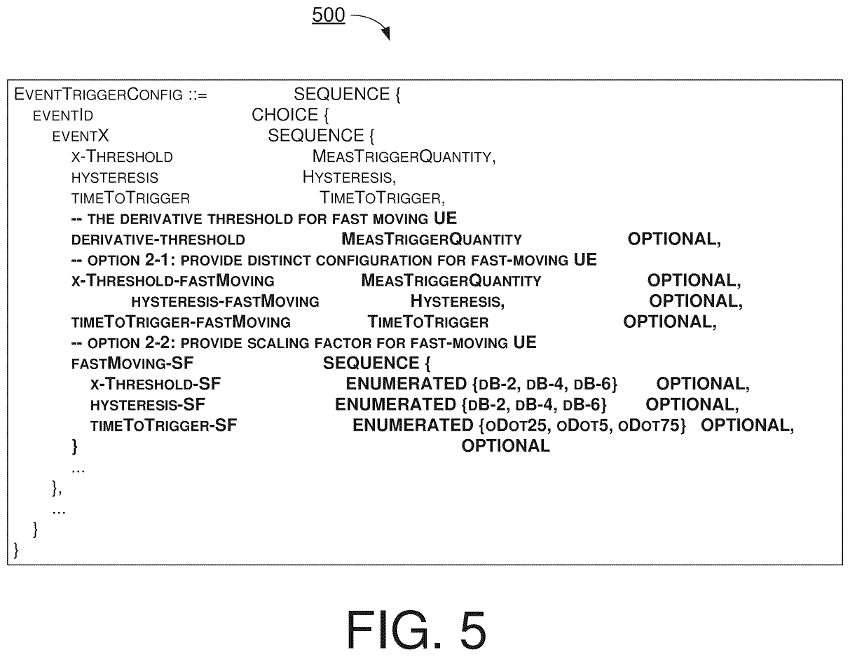

FIG. 5 is a diagram illustrating an example scenario 500 in which the network provides distinct or scaled event-triggering configurations for fast-moving UEs in the EventTriggerConfig structure. In scenario 500, the EventTriggerConfig may include a derivative-threshold parameter that allows the UE 210 to determine whether the temporal variation rate of radio measurements, such as the derivative of RSRP, RSRQ, or SINR over time, surpasses a specific threshold. Upon detecting that this condition is met, the UE 210 may apply alternative triggering criteria tailored for fast-moving conditions. Such criteria may include distinct fast-moving parameters, such as x-Threshold-fastMoving, hysteresis-fastMoving, and timeToTrigger-fastMoving, or may instead rely on scaling factors that adjust the original threshold, hysteresis, and time-to-trigger values using predefined step adjustments. By lowering these triggering parameters when the UE 210 is moving at high speed, the network enables earlier detection of mobility-critical signal variations and consequently allows measurement reporting to be triggered sooner, thereby enhancing the responsiveness and accuracy of mobility procedures in dynamic environments.

In another embodiment, in determining whether the temporal variation rate of measurement data should be included, the UE 210 may check/determine if the configuration parameters include the temporal variation rate option (e.g., derivativeResultAllow). If this setting is set to true in the MeasConfig, the UE 210 will include the derivative results in its measurement reports. When the temporal variation rate of the radio measurement data exceeds the threshold included in the measurement configuration, the UE 210 evaluates the measurement report criterion using the fast-moving event parameter set, including parameters such as x-Threshold-fastMoving, hysteresis-fastMoving, and timeToTrigger-fastMoving, which are tailored for fast-moving UE conditions. Otherwise, the UE 210 may adopt the legacy event parameters or legacy filter coefficients to process the event, based on the conventional event trigger settings. Additionally, when applicable, the UE 210 may apply scaling factors, such as x-Threshold-SF, which adjust the thresholds, hysteresis, and time-to-trigger parameters according to predefined step adjustments (e.g., dB-2, dB-4, or dB-6 for thresholds, and oDot25, oDot5, or oDot75 for time-to-trigger).

### Illustrative Implementations

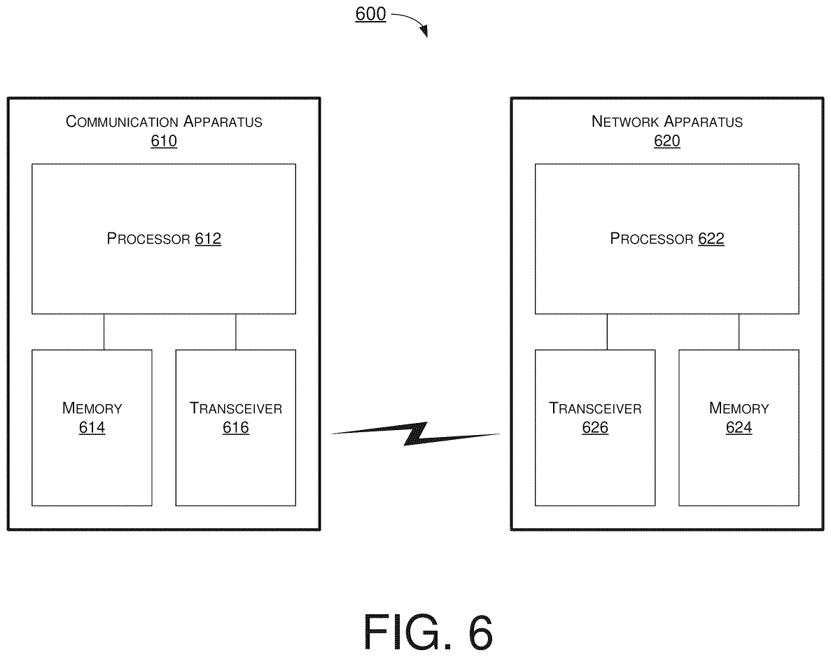

FIG. 6 illustrates an example communication system 600 having an example communication apparatus 610 and an example network apparatus 620 in accordance with an implementation of the present disclosure. Each of communication apparatus 610 and network apparatus 620 may perform various functions to implement schemes, techniques, processes and methods described herein pertaining to measurement report enhancement in mobile communications, including scenarios/schemes described above as well as process 700 and process 800 described below.

Communication apparatus 610 may be a part of an electronic apparatus, which may be a UE such as a portable or mobile apparatus, a wearable apparatus, a wireless communication apparatus, or a computing apparatus. For instance, communication apparatus 610 may be implemented in a smartphone, a smartwatch, a personal digital assistant, a digital camera, or a computing equipment such as a tablet computer, a laptop computer, or a notebook computer. Communication apparatus 610 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 610 may be implemented in a smart thermostat, a smart fridge, a smart door lock, a wireless speaker or a home control center. Alternatively, communication apparatus 610 may be implemented in the form of one or more integrated-circuit (IC) chips, such as, for example and without limitation, one or more single-core processors, one or more multi-core processors, one or more reduced-instruction set computing (RISC) processors, or one or more complex-instruction-set-computing (CISC) processors. Communication apparatus 610 may include at least some of those components shown in FIG. 6, such as a processor 612, for example. Communication apparatus 610 may further include one or more other components not pertinent to the proposed scheme of the present disclosure (e.g., internal power supply, display device and/or user interface device), and, thus, such component(s) of communication apparatus 610 are neither shown in FIG. 6 nor described below in the interest of simplicity and brevity.

Network apparatus 620 may be a part of a network apparatus, which may be a network node such as a satellite, a base station, a small cell, a router, a gateway, or other network element. For instance, network apparatus 620 may be implemented in an eNodeB in an LTE network, in a gNB in a 5G/NR, IoT, NB-IoT or IIoT network or in a satellite or base station in a 6G network. Alternatively, network apparatus 620 may be implemented in the form of one or more IC chips such as, for example and without limitation, one or more single-core processors, one or more multi-core processors, or one or more RISC or CISC processors. Network apparatus 620 may include at least some of those components shown in FIG. 6 such as a processor 622, for example. Network apparatus 620 may further include one or more other components not pertinent to the proposed scheme of the present disclosure (e.g., internal power supply, display device and/or user interface device), and, thus, such component(s) of network apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including measurement report enhancement in accordance with various implementations of the present disclosure.

In some implementations, communication apparatus 610 may also include a transceiver 616 coupled to processor 612 and capable of wirelessly transmitting and receiving data. In some implementations, communication apparatus 610 may further include a memory 614 coupled to processor 612 and capable of being accessed by processor 612 and storing data therein. In some implementations, network apparatus 620 may also include a transceiver 626 coupled to processor 622 and capable of wirelessly transmitting and receiving data. In some implementations, network apparatus 620 may further include a memory 624 coupled to processor 622 and capable of being accessed by processor 622 and storing data therein. Accordingly, communication apparatus 610 and network apparatus 620 may wirelessly communicate with each other via transceiver 616 and transceiver 626, respectively.

To aid better understanding, the following description of the operations, functionalities and capabilities of each of communication apparatus 610 and network apparatus 620 is provided in the context of a mobile communication environment in which communication apparatus 610 is implemented in or as a communication apparatus or a UE and network apparatus 620 is implemented in or as a network node of a communication network.

### Illustrative Processes

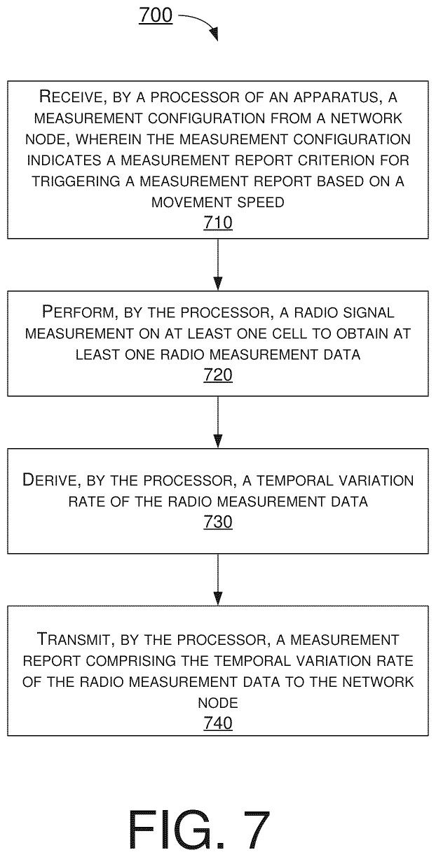

FIG. 7 illustrates an example process 700 in accordance with an implementation of the present disclosure. Process 700 may be an example implementation of above scenarios/schemes, whether partially or completely, with respect to measurement report enhancement of the present disclosure. Process 700 may represent an aspect of implementation of features of communication apparatus 610. Process 700 may include one or more operations, actions, or functions as illustrated by one or more of blocks 710 to 740. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by communication apparatus 610 or any suitable UE or machine type devices. Solely for illustrative purposes and without limitation, process 700 is described below in the context of communication apparatus 610. Process 700 may begin at block 710.

At block 710, process 700 may involve processor 612 of communication apparatus 610 receiving, via transceiver 616, a measurement configuration from a network node (e.g., network apparatus 620). The measurement configuration may indicate a measurement report criterion for triggering a measurement report based on a movement speed. Process 700 may proceed from block 710 to block 720.

At block 720, process 700 may involve processor 612 of communication apparatus 610 performing a radio signal measurement on at least one cell to obtain at least one radio measurement data. Process 700 may proceed from block 720 to block 730.

At block 730, process 700 may involve processor 612 of communication apparatus 610 deriving a temporal variation rate of the radio measurement data. Process 700 may proceed from block 730 to block 740.

At block 740, process 700 may involve processor 612 of communication apparatus 610 transmitting, via transceiver 616, a measurement report including the temporal variation rate of the radio measurement data to the network node.

In some implementations, process 700 may involve processor 612 of communication apparatus 610 transmitting the measurement report comprising the temporal variation rate of the radio measurement data in an event that parameters of the measurement configuration comprise a temporal variation rate parameter and the temporal variation rate parameter is set to true.

In some implementations, the measurement configuration may include at least one parameter associated with the temporal variation rate of the radio measurement data and at least one of a fast-moving event parameter set. The at least one parameter may include a threshold corresponding to the temporal variation rate of the radio measurement data for determining the movement speed.

In some implementations, process 700 may involve processor 612 of communication apparatus 610 evaluating the measurement report criterion using a fast-moving event parameter set when the temporal variation rate of the radio measurement data exceeds the threshold included in the measurement configuration. Otherwise, process 700 may involve processor 612 of communication apparatus 610 using legacy event parameters or legacy filter coefficients.

In some implementations, process 700 may involve processor 612 of communication apparatus 610 determining that the measurement report is triggered in an event that the temporal variation rate of the radio measurement data surpasses the threshold.

In some implementations, process 700 may involve processor 612 of communication apparatus 610 determining whether the temporal variation rate parameter is set to true.

In some implementations, the radio measurement data may include at least one of an RSRP, an RSRQ, and an SINR.

In some implementations, process 700 may involve processor 612 of communication apparatus 610 deriving a derivative of the radio measurement data over time.

In some implementations, process 700 may involve processor 612 of communication apparatus 610 determining an absolute value of the derivative of the radio measurement data over time.

In some implementations, the derivative of the radio measurement data over time may include at least one derivative of an RSRP over time, an RSRQ over time, and an SINR over time.

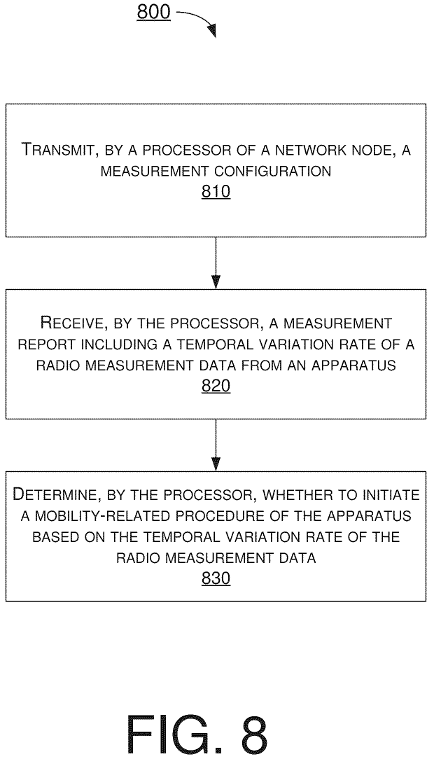

FIG. 8 illustrates an example process 800 in accordance with an implementation of the present disclosure. Process 800 may be an example implementation of above scenarios/schemes, whether partially or completely, with respect to measurement report enhancement in mobile communications. Process 800 may represent an aspect of implementation of features of network apparatus 620. Process 800 may include one or more operations, actions, or functions as illustrated by one or more of blocks 810 to 840. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may be implemented by network apparatus 620 or any base stations or network nodes. Solely for illustrative purposes and without limitation, process 800 is described below in the context of network apparatus 620. Process 800 may begin at block 810.

At block 810, process 800 may involve processor 622 of network apparatus 620 transmitting, via transceiver 626, a measurement configuration. Process 800 may proceed from block 810 to block 820.

At block 820, process 800 may involve processor 622 of network apparatus 620 receiving, via transceiver 626, a measurement report including a temporal variation rate of a radio measurement data from an apparatus (e.g., communication apparatus 610). Process 800 may proceed from block 820 to block 830

At block 830, process 800 may involve processor 622 of network apparatus 620 determining whether to initiate a mobility-related procedure of the apparatus based on the temporal variation rate of the radio measurement data.

In some implementations, the measurement configuration may include at least one parameter associated with the temporal variation rate of the radio measurement data and at least one fast-moving event parameter set.

In some implementations, the at least one parameter associated with the temporal variation rate of the radio measurement data may include a threshold corresponding to the temporal variation rate of the radio measurement data for determining a movement speed.

In some implementations, the temporal variation rate of the radio measurement data may include a derivative of at least one of an RSRP, an RSRQ, and an SINR over time.

In some implementations, process 800 may involve processor 622 of network apparatus 620 initiating the mobility-related procedure in an event that the temporal variation rate surpasses a threshold.

In some implementations, the mobility-related procedure may include a handover procedure.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a measurement configuration from a network node, wherein the measurement configuration indicates a measurement report criterion for triggering a measurement report based on a movement speed;
performing, by the processor, a radio signal measurement on at least one cell to obtain at least one radio measurement data;
deriving, by the processor, a temporal variation rate of the radio measurement data; and
transmitting, by the processor, a measurement report comprising the temporal variation rate of the radio measurement data to the network node.

2. The method of claim 1, wherein the measurement configuration comprises at least one parameter associated with the temporal variation rate of the radio measurement data and at least one fast-moving event parameter set, and wherein the at least one parameter comprises a threshold corresponding to the temporal variation rate of the radio measurement data for determining the movement speed.

3. The method of claim 2, further comprising:
evaluating, by the processor, the measurement report criterion using the fast-moving event parameter set when the temporal variation rate of the radio measurement data exceeds the threshold included in the measurement configuration.

4. The method of claim 1, wherein the transmitting of the measurement report comprising the temporal variation rate of the radio measurement data is performed in an event that parameters of the measurement configuration comprise a temporal variation rate parameter and the temporal variation rate parameter is set to true.

5. The method of claim 4, wherein the transmitting of the measurement report comprising the temporal variation rate of the radio measurement data comprises:
determining, by the processor, whether the temporal variation rate parameter is set to true.

6. The method of claim 1, wherein the deriving of the temporal variation rate comprises:
deriving a derivative of the radio measurement data over time.

7. The method of claim 6, wherein the derivative of the radio measurement data over time comprises at least one derivative of a reference signal received power (RSRP) over time, a reference signal received quality (RSRQ) over time, and a signal to interference plus noise ratio (SINR) over time.

8. A method, comprising:
transmitting, by a processor of a network node, a measurement configuration;
receiving, by the processor, a measurement report comprising a temporal variation rate of at least one radio measurement data from an apparatus; and
determining, by the processor, whether to initiate a mobility-related procedure of the apparatus based on the temporal variation rate of the radio measurement data.

9. The method of claim 8, wherein the measurement configuration comprises at least one parameter associated with the temporal variation rate of the radio measurement data and at least one fast-moving event parameter set.

10. The method of claim 9, wherein the at least one parameter associated with the temporal variation rate of the radio measurement data comprises a threshold corresponding to the temporal variation rate of the radio measurement data for determining a movement speed.

11. The method of claim 8, wherein the temporal variation rate of the radio measurement data comprises a derivative of at least one of a reference signal received power (RSRP), a reference signal received quality (RSRQ), and a signal to interference plus noise ratio (SINR) over time.

12. The method of claim 8, wherein the determining of whether to initiate the mobility-related procedure further comprises:
initiating, by the processor, the mobility-related procedure in an event that the temporal variation rate surpasses a threshold.

13. The method of claim 12, wherein the mobility-related procedure comprises a handover procedure.

14. An apparatus, comprising:
a transceiver which, during operation, communicates wirelessly; and
a processor communicatively coupled to the transceiver such that, during operation, the processor performs operations comprising:
receiving, via the transceiver, a measurement configuration from a network node, wherein the measurement configuration indicates a measurement report criterion for triggering a measurement reporting based on a movement speed;
performing a radio signal measurement on at least one cell to obtain at least one radio measurement data;
deriving a temporal variation rate of the radio measurement data; and
transmitting, via the transceiver, a measurement report comprising the temporal variation rate of the radio measurement data to the network node.

15. The apparatus of claim 14, wherein the measurement configuration comprises at least one parameter associated with the temporal variation rate of the radio measurement data and at least one fast-moving event parameter set, and wherein the at least one parameter comprises a threshold corresponding to the temporal variation rate of the radio measurement data for determining the movement speed.

16. The apparatus of claim 15, wherein, during operation, the processor further performs operations comprising:
evaluating the measurement report criterion using the fast-moving event parameter set when the temporal variation rate of the radio measurement data exceeds the threshold included in the measurement configuration.

17. The apparatus of claim 14, wherein the transmitting of the measurement report comprising the temporal variation rate of the radio measurement data is performed in an event that parameters of the measurement configuration comprise a temporal variation rate parameter and the temporal variation rate parameter is set to true.

18. The apparatus of claim 17, wherein, during operation, the processor further performs operations comprising:
determining whether the temporal variation rate parameter is set to true.

19. The apparatus of claim 14, wherein, in deriving the temporal variation rate, the processor performs operations comprising:
deriving a derivative of the radio measurement data over time.

20. The apparatus of claim 19, wherein the derivative of the radio measurement data over time comprises at least one of a reference signal received power (RSRP) over time, a reference signal received quality (RSRQ) over time, and a signal to interference plus noise ratio (SINR) over time.
